(19) United States
(12) Patent Application Publication
(10) Pub. No.: US 2011/0054982 A1
(43) Pub. Date: Mar. 3, 2011

(54) METHODS AND SYSTEMS FOR RANDOMIZING STARTING RETAIL STORE INVENTORY WHEN DETERMINING DISTRIBUTION CENTER AND WAREHOUSE DEMAND FORECASTS

(76) Inventors: Edward Kim, Toronto (CA); Arash Bateni, Toronto (CA); David Chan, Toronto (CA); Fred Narduzzi, Markham (CA)

(21) Appl. No.: 12/644,063

(22) Filed: Dec. 22, 2009

Related U.S. Application Data
(60) Provisional application No. 61/239,046, filed on Sep. 1, 2009.

(51) Int. Cl. G06Q 10/00

(52) U.S. Cl. 705/10; 705/28

(57) ABSTRACT

A method and system for determining distribution center or warehouse product order quantities of a slow selling product. The method includes the step of determining for each one of a plurality of stores supplied by the distribution center, a store order forecast for the slow selling product. The method generates a random beginning on-hand inventory value for stores with inventories below a minimum inventory threshold value. Store order forecasts are thereafter determined by subtracting the random beginning on-hand inventory value from store sales forecasts when the beginning on-hand inventory value is less than the minimum inventory threshold value, and subtracting the actual beginning on-hand inventory value from the store sales forecasts when the beginning on-hand inventory value is not less than the minimum inventory threshold value. The individual store order forecasts are accumulated to generate a distribution center demand forecast; which is compared with current and projected inventory levels for the product at the distribution center to determine distribution center order quantities necessary for maintaining a product inventory level sufficient to meet the distribution center demand forecast for the product.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/239,046, entitled “METHODS AND SYSTEMS FOR RANDOMIZING STARTING RETAIL STORE INVENTORY WHEN DETERMINING DISTRIBUTION CENTER AND WAREHOUSE DEMAND FORECASTS” by Edward Kim, Arash Bateni, David Chan, and Fred Narduzzi; filed on Sep. 1, 2009.

This application is related to the following co-pending and commonly-assigned patent applications, which are incorporated by reference herein:

Application Ser. No. 10/875,456, entitled “METHODS AND SYSTEMS FOR SYNCHRONIZING DISTRIBUTION CENTER AND WAREHOUSE DEMAND FORECASTS WITH RETAIL STORE DEMAND FORECASTS” by Edward Kim, Pat McDaid, Mardie Noble, and Fred Narduzzi; filed on Jun. 24, 2004; and

Application Ser. No. 10/737,056, entitled “METHODS AND SYSTEMS FOR FORECASTING FUTURE ORDER REQUIREMENTS” by Fred Narduzzi, David Chan, Blair Bishop, Richard Powell-Brown, Russell Sumiya and William Cortes; filed on Dec. 16, 2003.

### FIELD OF THE INVENTION

The present invention relates to methods and systems for forecasting product demand for distribution center or warehouse operations; and in particular to an improved method and system for determining distribution center or warehouse order forecasts from store forecasts of slow selling products.

### BACKGROUND OF THE INVENTION

Today's competitive business environment demands that retailers be more efficient in managing their inventory levels to reduce costs and yet fulfill demand. To accomplish this, many retailers are developing strong partnerships with their vendors/suppliers to set and deliver common goals. One of the key business objectives both the retailer and vendor are striving to meet is customer satisfaction by having the right merchandise in the right locations at the right time. To that effect it is important that vendor production and deliveries become more efficient. The inability of retailers and suppliers to synchronize the effective distribution of goods through the distribution facilities to the stores has been a major impediment to both maximizing productivity throughout the demand chain and effectively responding to the needs of the consumer.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. The individual store product forecasts can thereafter be accumulated and used to determine the appropriate amounts of products to order from a product warehouse or distribution center to meet customer demand. The warehouse must in turn order appropriate amounts from suppliers and vendors based on its demand forecast.

Some currently used methods for forecasting product sales and determining suggested store order quantities (SOQs) include beginning on-hand (BOH) inventory levels in the determination of suggested store order quantities. Although fine for use at the store level, and for most products at the warehouse and distribution center levels, these forecasting methods may produce problematic results when used to determine warehouse or distribution center orders for low inventory, very slow selling products. Described below is an improved methodology for forecasting product sales and determining suggested store order quantities and warehouse demand forecasts for low inventory, very slow selling products.

### BRIEF DESCRIPTION OF THE DRAWINGS

FIG. 1 provides an illustration of a product supply/demand chain from a supplier and manufacturer to a retail store and customer.

FIG. 2 is process flow diagram illustrating a synchronized DC/warehouse forecasting and replenishment process.

FIG. 3 is a high level block diagram illustration of a process for determining DC/warehouse demand from an accumulation of store suggested order quantity (SOQ) data.

FIG. 4 is a high level block diagram illustration of a process for determining DC/warehouse demand from a roll-up of store long range order forecasts in accordance with the present invention.

FIG. 5A illustrates the total demand forecast and accumulated suggested order quantity forecast for a very low selling product sold at a number of stores over a sixty-five week period.

FIG. 5B illustrates the effective total inventory of the product of FIG. 5A over the same sixty-five week period.

FIG. 6 provides a simple flow diagram of a process for randomizing beginning on-hand inventory in order to when forecasting product sales and determining suggested store order quantities for low inventory, very slow selling products.

FIG. 7A illustrates the total demand forecast and accumulated suggested order quantity forecast for a very low selling product sold at a number of stores over a sixty-five week period following implementation of the process illustrated in FIG. 6.

FIG. 7B illustrates the effective total inventory of the product of FIG. 7A following implementation of the process illustrated in FIG. 6.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

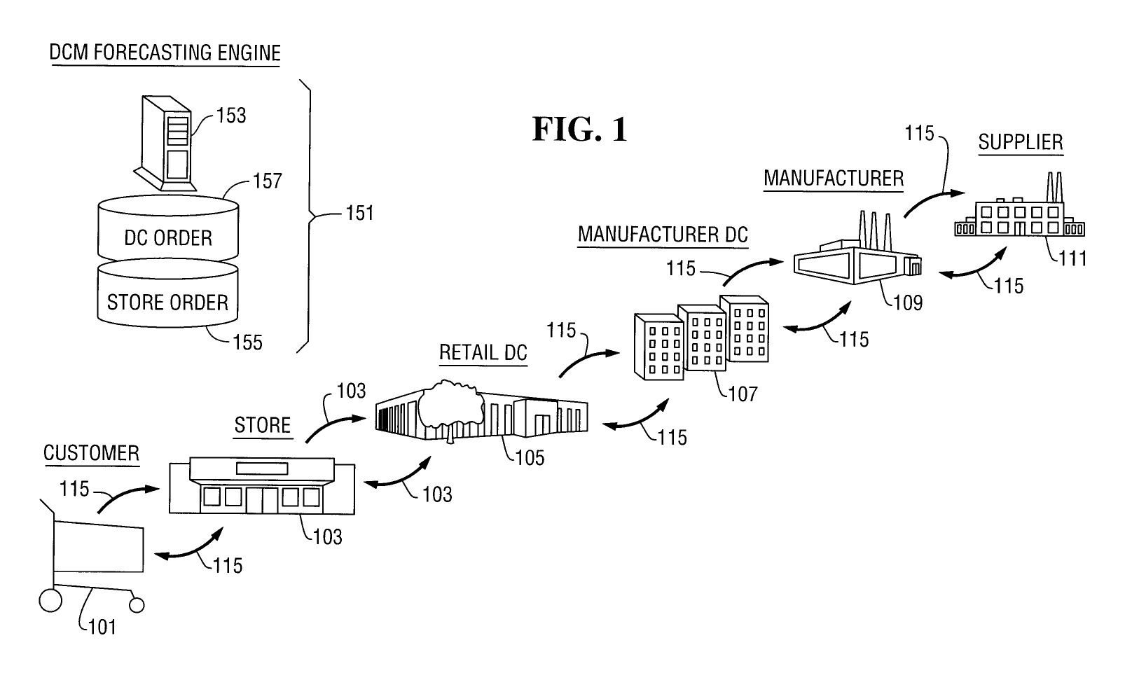

FIG. 1 provides an illustration of a retail demand/supply chain from a customer 101 to a retail store 103, retail distribution center/warehouse 105, manufacturer distribution center/warehouse 107, manufacturer 109 and supplier 111. Arrows 115 are used to illustrate communication between the demand/supply chain entities. The Teradata Demand Chain Management system 151 includes product demand forecasting, planning and replenishment applications executed on server 153 which determine store order quantities 155 and distribution center forecasts 157, and provide for the synchronization of the warehouse/distribution center replenishment system with the replenishment ordering systems from the supported stores.

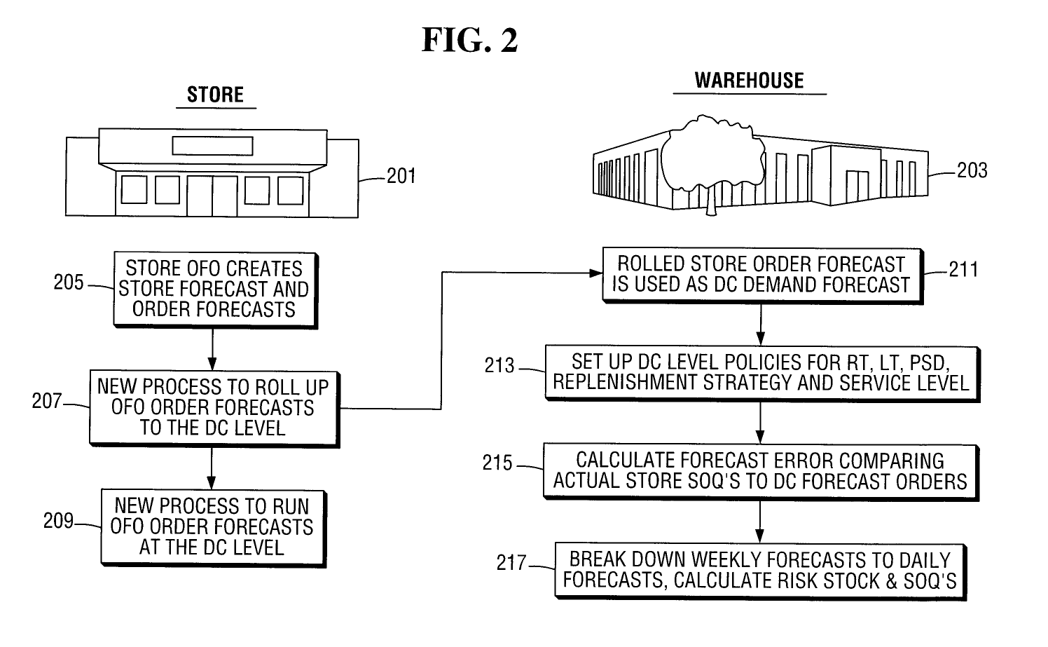

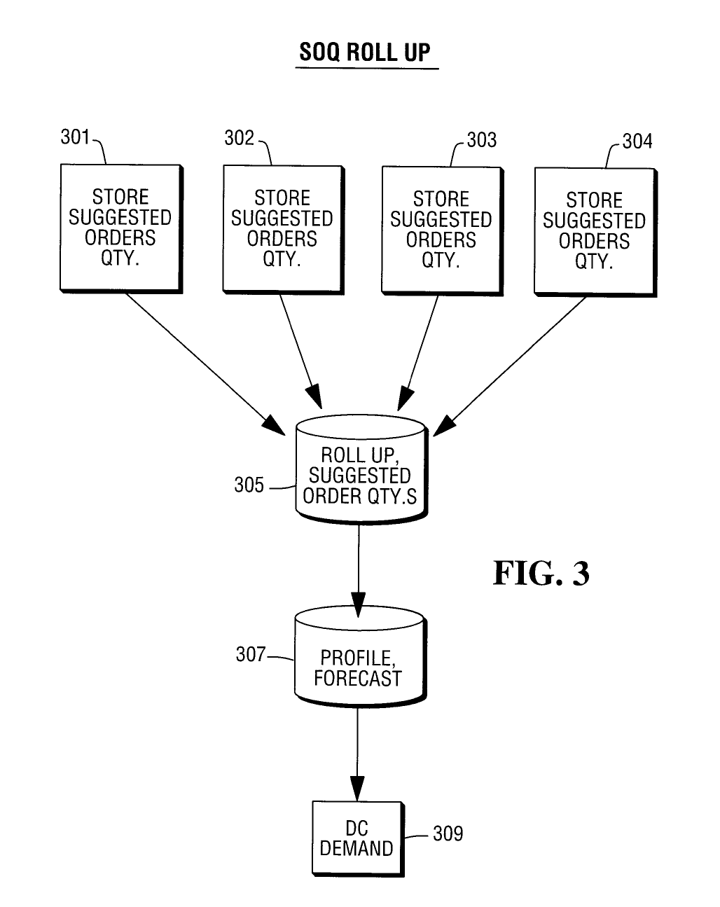

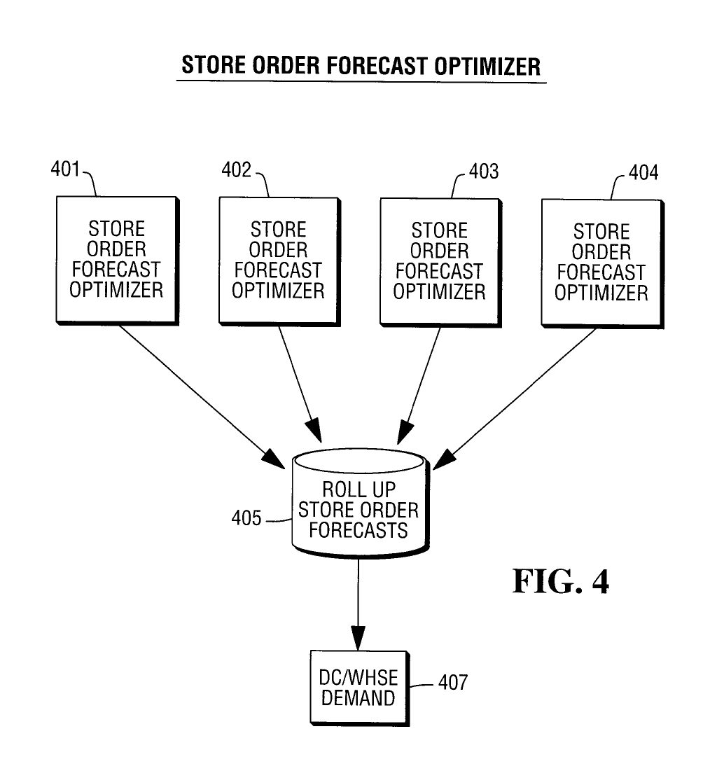

A synchronized DC/warehouse forecasting and replenishment process is illustrated in the process flow diagram of FIG. 2. Beginning at step 205, each retail store 201 supplied by warehouse 203 creates a store forecast and order forecast utilizing a methodology such as the methods illustrated in FIG. 3 or 4. In step 207, the individual store order forecasts are accumulated to the DC/warehouse level. This rolled-up order forecast is provided to the DC/warehouse 203 for use as the DC/warehouse demand forecast, as shown in step 211.

In step 213, DC/warehouse level policies may be established for RT (Review Time from last time the replenishment system was run), LT (Lead Time from the order being cut to the delivery of product), PSD (Planned Sales Days, the amount of time the Effective Inventory should service the forecast demand), Replenishment Strategy, and Service Level. In step 215, forecast error is calculated comparing actual store suggested order quantities (SOQs) to DC/warehouse forecast orders. Finally, in step 217, weekly forecasts are broken down to determine daily forecasts, calculate safety stock and SOQs. Safety Stock is the statistical risk stock needed to meet a certain service level for a given order quantity. The safety stock is a function of lead times, planned sales days, service level and forecast error.

There are several methods that can be utilized to produce DC/warehouse demand forecasts. Two methods for generating DC/warehouse demand forecasts, illustrated in FIGS. 3 and 4, are described below. FIG. 3 illustrates a process where DC/warehouse demand forecasts are determined from roll up of Suggested Order Quantities (SOQs). Suggested Order Quantity information from numerous store locations 301-304 is aggregated 305 and used to generate DC/warehouse profile and weekly, monthly or quarterly forecasts 307. This method takes into account lead times, seasonality and recent trends in both store and DC/warehouse requirements. The SOQ represents true DC/warehouse demand from stores as it calculates demand for the stocking period (planned sales days), considers lost sales where they exist and subtracts the effective inventory (on hand and on order) in building the correct store orders.

FIG. 4 is a high level illustration of a process wherein store order forecasts determined for numerous retail stores 401-404 are accumulated 405 to create the DC/warehouse Synchronized Demand 407. Store order forecasts are determined through the process described in application Ser. No. 10/737,056, referred to above and incorporated by reference herein. The DC/warehouse replenishment orders will be executed considering all stores' time-phased needs net of effective inventory and applying the DC/warehouse's lead time, planned sales days, forecast error and service levels.

In the processes shown in FIGS. 3 and 4 discussed above, the Suggested Order Quantity (SOQ) or store order forecast for a product is determined by subtracting the effective inventory of the product from the DCM demand forecast for the product. The effective inventory of the product includes the current or beginning inventory of the product, also referred to a beginning on-hand (BOH) stock, plus additional inventory expected to be received by the store prior to the demand forecast period, less expected sales of the product prior to the demand forecast period.

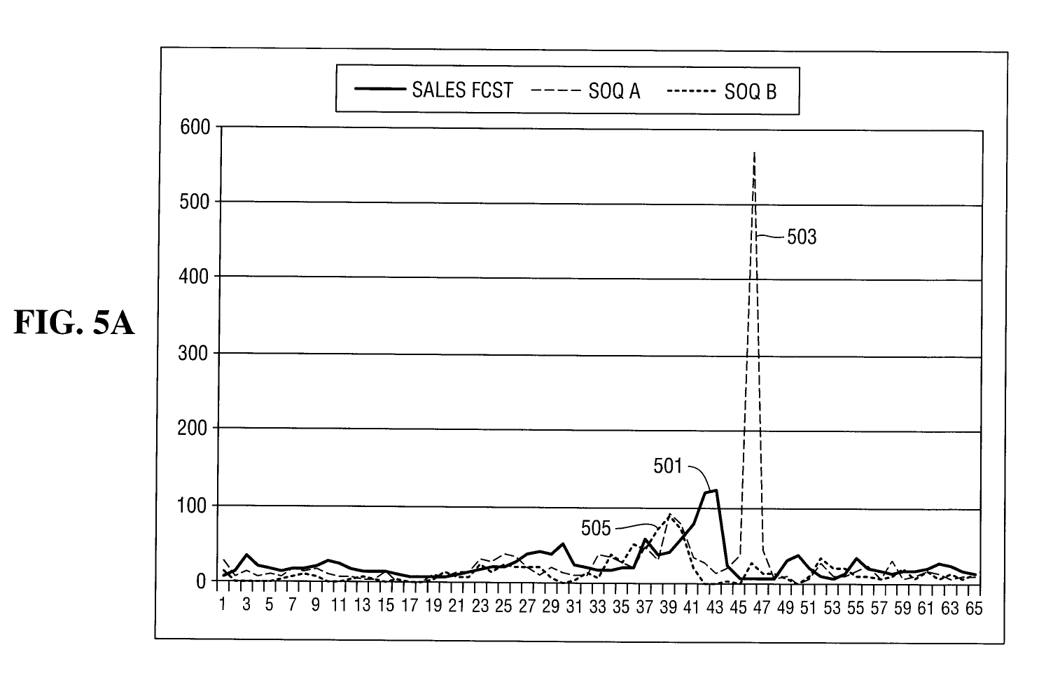

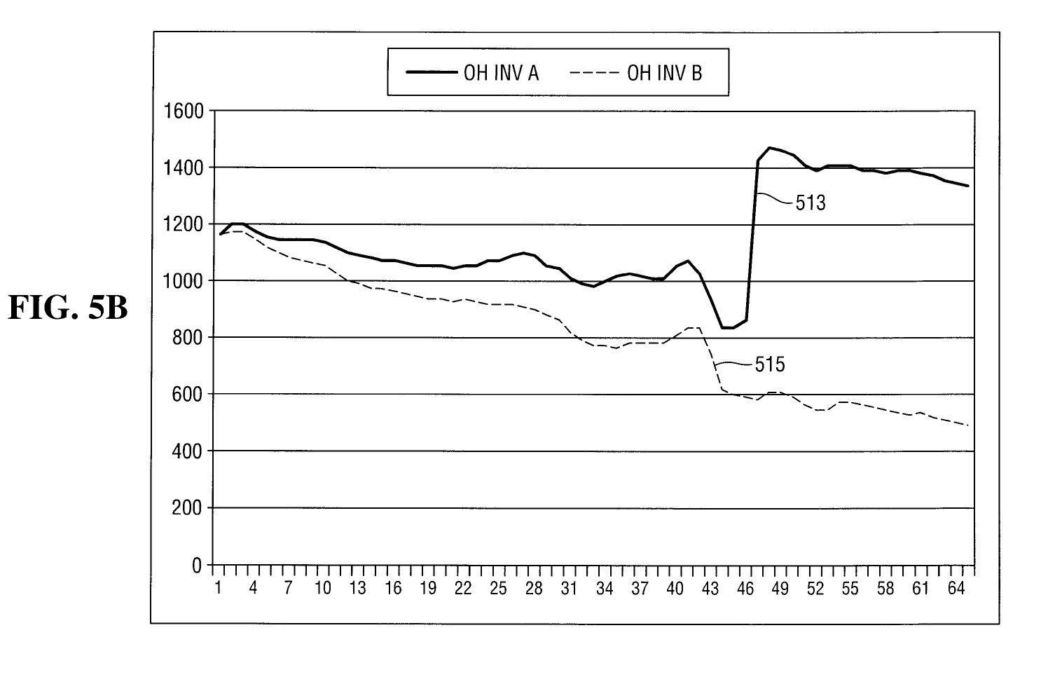

As stated above, some currently used methods for forecasting product sales and determining suggested store order quantities (SOQs) may produce problematic results when used to determine warehouse or distribution center orders for low inventory, very slow selling products. FIGS. 5A and 5B are provided to illustrate this problem. The graphs of FIG. 5A illustrate the total demand forecast and accumulated suggested order quantity forecast for a very low selling product sold at 1100 stores over a sixty-five week period. The graphs of FIG. 5B show the effective total inventory level of the product over that same sixty-five week period. In this example, the most stores have a beginning on-hand inventory of 1 unit, the same weekly average rate of sales (ARS), and decrement on-hand inventory by the same amount every week. Product forecast unit sales and inventory levels are measured against the vertical axis in FIGS. 5A and 5B, respectively. Sales weeks are measured along the horizontal axis in both figures.

Graph 501 of FIG. 5A illustrates the DCM system generated sales forecast for a representative product with a low average rate of sales of 0.024 units/week, i.e., approximately 1 sale every 42 weeks. With a requirement that a minimum stock of 1 unit be maintained at each store, the warehouse or distribution center (DC) suggested order quantities and total store effective inventory levels generated by the DCM system are illustrated by graph 503 of FIG. 5A and graph 513 of FIG. 5B, respectively. Without the requirement that a minimum stock of 1 unit be maintained at each store, the DC suggested order quantities and total store effective inventory levels generated by the DCM system are illustrated by graph 505 of FIG. 5A and graph 515 of FIG. 5B, respectively.

As can be seen in graphs 501, 503, and 513, for the product having an ARS of 0.24, a beginning inventory of 1 at most stores, and a requirement that a minimum stock of 1 unit be maintained at each store, the DCM system will forecast a significant number of product sales near week 42 of the forecast period, followed by a drop in the effective inventory of the product, and a very large DC SOQ at week 46. In this scenario, most of the 1100 stores will order replenishment stock during the same week, week 46, a potentially problematic situation for the warehouse, distribution center, or product manufacturer. A higher or lower ARS for the product will vary the week in which the week in which the spike in SOQ occurs.

Without the requirement that a minimum stock of 1 unit be maintained at each store, graphs 501, 505, and 515 show that the DCM system will forecast a significant number of product sales near week 42 of the forecast period, followed by a drop in the effective inventory of the product, but a replenishment SOQ will not be generated until after the 65 week forecast period. The effective inventory levels are significantly lower without the requirement that a minimum stock of 1 unit be maintained at each store. Following week 46, the effective inventory for the product drops to below 600 units, well below the inventory level needed to meet the potential demand at all locations. This may cause insufficient orders and frequent stock-outs, resulting in lost product sales.

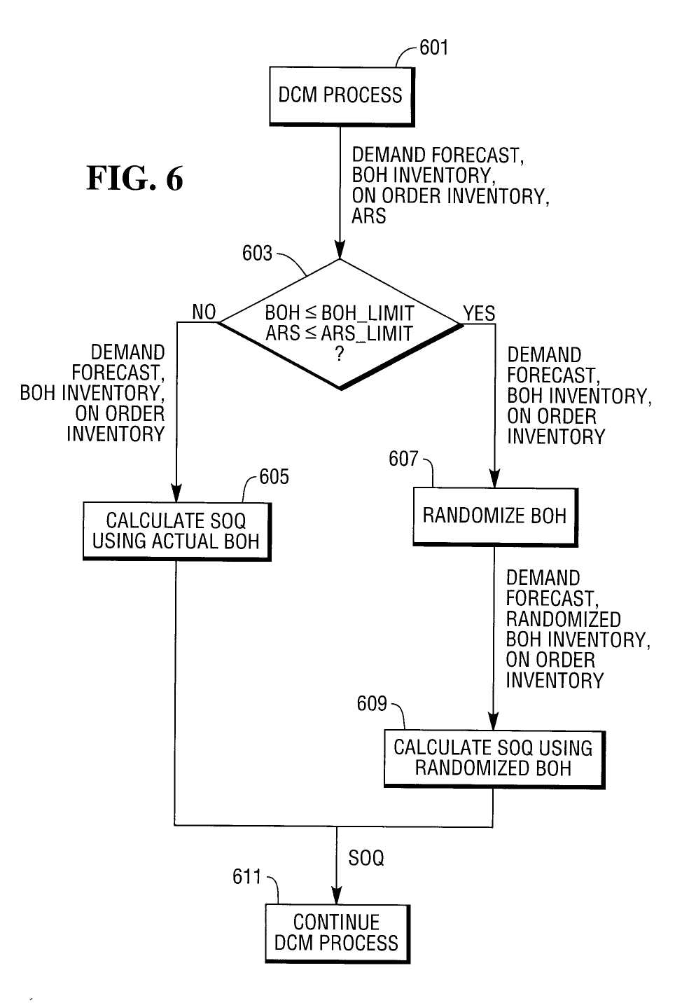

FIG. 6 presents a simple flow diagram of a process for randomizing beginning on-hand inventory in order to ameliorate the process for forecasting product sales and determining suggested store order quantities for low inventory, very slow selling products. Referring to FIG. 6, the DCM forecasting system provides a store demand forecast, beginning on-hand inventory level, on order inventory value, and average rate of sale value for a product in step 601. In step 603, the beginning on-hand inventory level and average rate of sale value are compared to limit values for these values to determine if the product is to be treated as a very slow selling product. In the example discussed herein, the BOH limit is 1 unit, and the ARS limit is 0.1 units per week.

If either, or both, the beginning on-hand inventory level and average rate of sale value exceed their respective limit value, the product will not be considered a very low selling product, and in accordance with step 605 the suggested order quantity for the product is determined by subtracting the effective inventory value, i.e., the on hand and on order inventory values, of the product from the DCM demand forecast for the product. The DCM forecasting process continues in step 611 with the SOQ determined in step 605 for these products.

When both the beginning on-hand inventory level and average rate of sale value for a product falls below the BOH and ARS limit values, the product will be considered a very low selling product, and a randomized BOH level will be assigned to the product in step 607. In the example discussed herein, a BOH level of 1 unit is randomized to a value between 0.55 and 1.45 units. In step 609, the suggested order quantity for the product is determined by subtracting the randomized beginning on hand inventory value and the on order inventory value from the DCM demand forecast for the product. The DCM forecasting process continues in step 611 with the SOQ determined in step 609 for the very low selling products. Store SOQs are accumulated to determine the warehouse or distribution center SOQs.

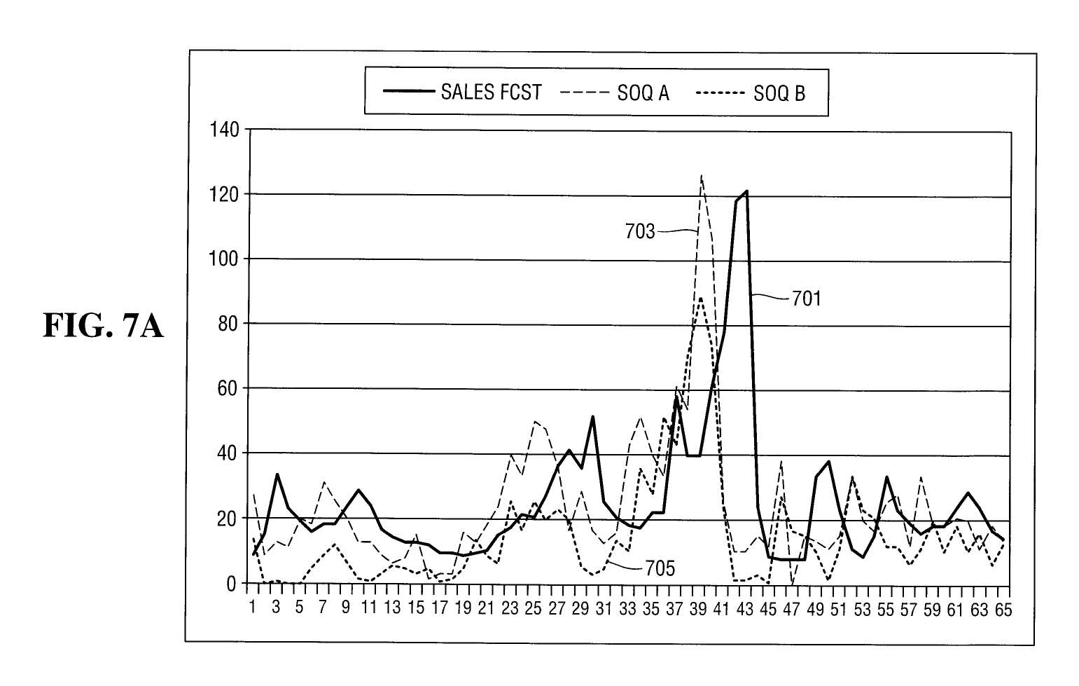

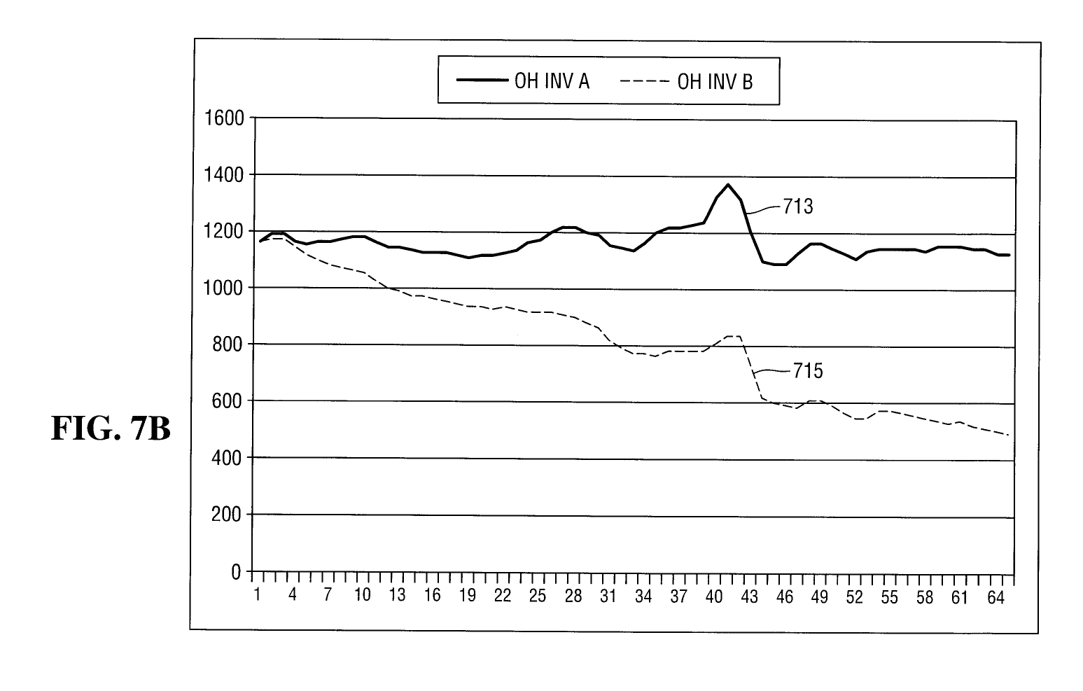

The graphs of FIG. 7A illustrate the total demand forecast and accumulated suggested order quantity forecast for the product of FIGS. 5A and 5B utilizing the process for randomizing beginning on-hand inventory described above. The graphs of FIG. 7B show the effective total inventory level of the product of FIGS. 5A and 5B utilizing the process for randomizing beginning on-hand inventory described above.

Graph 701 of FIG. 7A illustrates the DCM system generated sales forecast for a representative product with a low average rate of sales of 0.024 units/week, i.e., approximately 1 sale every 42 weeks. This is the same graph as graph 501 of FIG. 5A with a larger scale along the vertical axis. With a requirement that a minimum stock of 1 unit be maintained at each store, and a randomized beginning on-hand inventory, the warehouse or distribution center (DC) suggested order quantities and total store effective inventory levels generated by the DCM system are illustrated by graph 703 of FIG. 7A and graph 713 of FIG. 7B, respectively. Without the requirement that a minimum stock of 1 unit be maintained at each store, the DC suggested order quantities and total store effective inventory levels generated by the DCM system are illustrated by graph 705 of FIG. 7A and graph 715 of FIG. 7B, respectively.

Comparing graph 703 of FIG. 7A with graph 503 of FIG. 5A, it is seen that when the beginning on-hand product inventory values are randomized to a value of between 0.55 and 1.45, rather than using a BOH of 1 for most stores, it is seen that the spike in DC SOQ shown in week 46 in graph 503 is greatly reduced, and the SOQs preceding week 46 have been increased slightly. The inventory levels displayed in Graph 713 of FIG. 7A also show less variation than those in FIG. 513 of 5A. From viewpoint of the DC or warehouse, the total effective inventory is unchanged. However, as the DCM system iterates through week by week, each store has a different effective inventory since they now start with different beginning on-hand inventory levels. This results in stores placing replenishment orders in different weeks, rather than the majority of stores ordering at the same week, week 46 of FIG. 5A.

Graphs 705 and 715 of FIGS. 7A and 7B show little change from corresponding graphs 505 and 515B of FIGS. 5A and 5B. Randomizing the beginning on-hand inventory levels without the requirement that a minimum stock of 1 unit be maintained at each store, has negligible effect on the DC SOQs and product inventory levels.

The improved methodology for forecasting product sales and determining suggested store order quantities and warehouse demand forecasts described above provides an advantage in that it closely simulates the actual selling model of an item across multiple stores. Randomizing the initial inventory has the desired effect of simulating a store's sale of the item at different random weeks throughout the year. That is, a slow selling item does not sell on the same day or week across all stores of a chain. Also, the randomization algorithm guarantees approximately the same number of aggregate inventory units whether there are 100 or 1000 locations, due to the independence of the random number generator. Hence, it is a scalable solution, with no regard for determining whether there is a certain threshold of stores which meet some criteria.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for determining product order quantities required to meet future product demands for a distribution center, the method comprising the steps of:
for each one of a plurality of stores:
comparing, by a computer, a beginning on-hand inventory value for said product with a minimum beginning inventory threshold value;
generating, by said computer, a random beginning on-hand inventory value for said product when said beginning on-hand inventory value is less than said minimum beginning inventory threshold value;
determining, by said computer, a sales forecast for said product; and
determining, by said computer, a store order forecast for said product, said store order forecast being determined by subtracting said random beginning on-hand inventory value from said sales forecast when said beginning on-hand inventory value is less than said minimum beginning inventory threshold value, and subtracting said beginning on-hand inventory value from said sales forecast when said beginning on-hand inventory value is not less than said minimum beginning inventory threshold value;
accumulating, by said computer, said store order forecasts for said plurality of retail stores to generate a distribution center demand forecast for said distribution center;
comparing, by said computer, said distribution center demand forecast with current and projected future inventory levels at said distribution center of said product; and
determining, by said computer, from distribution center demand forecast and said current and projected future inventory levels distribution center suggested order quantities necessary for maintaining a minimum inventory level sufficient to meet said distribution center demand forecast for said product.

2. The computer-implemented method for determining product order quantities in accordance with claim 1, wherein:
said minimum beginning inventory threshold value is one unit; and
said random beginning on-hand inventory value comprises a value between 0.55 and 1.45 units.

3. The computer-implemented method for determining product order quantities in accordance with claim 1, further comprising the steps of:
for each one of said plurality of stores, determining, by said computer, an average rate of sale of said product;
for each one of said plurality of stores, comparing, by said computer, said average rate of sale to an average rate of sale threshold value; and
determining, by said computer, said store order forecast by subtracting said random beginning on-hand inventory value from said sales forecast when said beginning on-hand inventory value is less than said minimum beginning inventory threshold value and said average rate of sale is less than said average rate of sale threshold value, and subtracting said beginning on-hand inventory value from said sales forecast when said beginning on-hand inventory value is not less than said minimum beginning inventory threshold value and said average rate of sale is not less than said average rate of sale threshold value.

4. A computer-implemented method for determining product order quantities for a store, the method comprising the steps of:
comparing, by a computer, a beginning on-hand inventory value for said product with a minimum beginning inventory threshold value;
generating, by said computer, a random beginning on-hand inventory value for said product when said beginning on-hand inventory value is less than said minimum beginning inventory threshold value;
determining, by said computer, a sales forecast for said product; and
determining, by said computer, a store order forecast for said product, said store order forecast being determined by subtracting said random beginning on-hand inventory value from said sales forecast when said beginning on-hand inventory value is less than said minimum beginning inventory threshold value, and subtracting said beginning on-hand inventory value from said sales forecast when said beginning on-hand inventory value is not less than said minimum beginning inventory threshold value.

5. The computer-implemented method for determining product order quantities in accordance with claim 4, wherein:
said minimum beginning inventory threshold value is one unit; and
said random beginning on-hand inventory value comprises a value between 0.55 and 1.45 units.

6. The computer-implemented method for determining product order quantities in accordance with claim 4, further comprising the steps of:
for each one of said plurality of stores, determining, by said computer, an average rate of sale of said product;
for each one of said plurality of stores, comparing, by said computer, said average rate of sale to an average rate of sale threshold value; and
determining, by said computer, said store order forecast by subtracting said random beginning on-hand inventory value from said sales forecast when said beginning on-hand inventory value is less than said minimum beginning inventory threshold value and said average rate of sale is less than said average rate of sale threshold value, and subtracting said beginning on-hand inventory value from said sales forecast when said beginning on-hand inventory value is not less than said minimum beginning inventory threshold value and said average rate of sale is not less than said average rate of sale threshold value.

7. A system for determining product order quantities required to meet future product demands for a distribution center, the system comprising:
a computer for:
comparing, for each one of a plurality of stores, a beginning on-hand inventory value for said product with a minimum beginning inventory threshold value;
generating, for each one of a plurality of stores, a random beginning on-hand inventory value for said product when said beginning on-hand inventory value is less than said minimum beginning inventory threshold value;
determining, for each one of a plurality of stores, a sales forecast for said product; and
determining, for each one of a plurality of stores, a store order forecast for said product, said store order forecast being determined by subtracting said random beginning on-hand inventory value from said sales forecast when said beginning on-hand inventory value is less than said minimum beginning inventory threshold value, and subtracting said beginning on-hand inventory value from said sales forecast when said beginning on-hand inventory value is not less than said minimum beginning inventory threshold value;
accumulating, said store order forecasts for said plurality of retail stores to generate a distribution center demand forecast for said distribution center;
comparing said distribution center demand forecast with current and projected future inventory levels at said distribution center of said product; and
determining from distribution center demand forecast and said current and projected future inventory levels distribution center suggested order quantities necessary for maintaining a minimum inventory level sufficient to meet said distribution center demand forecast for said product.

8. The system according to claim 7, wherein:
said minimum beginning inventory threshold value is one unit; and
said random beginning on-hand inventory value comprises a value between 0.55 and 1.45 units.

9. The system according to claim 7, wherein said computer:
determines, for each one of said plurality of stores, an average rate of sale of said product;
compares, for each one of said plurality of stores, said average rate of sale to an average rate of sale threshold value; and
determines said store order forecast by subtracting said random beginning on-hand inventory value from said sales forecast when said beginning on-hand inventory value is less than said minimum beginning inventory threshold value and said average rate of sale is less than said average rate of sale threshold value, and subtracting said beginning on-hand inventory value from said sales forecast when said beginning on-hand inventory value is not less than said minimum beginning inventory threshold value and said average rate of sale is not less than said average rate of sale threshold value.

10. A system for determining product order quantities for a store, the system comprising:
a computer for:
comparing a beginning on-hand inventory value for said product with a minimum beginning inventory threshold value;
generating a random beginning on-hand inventory value for said product when said beginning on-hand inventory value is less than said minimum beginning inventory threshold value;
determining a sales forecast for said product; and
determining a store order forecast for said product, said store order forecast being determined by subtracting said random beginning on-hand inventory value from said sales forecast when said beginning on-hand inventory value is less than said minimum beginning inventory threshold value, and subtracting said beginning on-hand inventory value from said sales forecast when said beginning on-hand inventory value is not less than said minimum beginning inventory threshold value.

11. The system according to claim 10, wherein:
said minimum beginning inventory threshold value is one unit; and
said random beginning on-hand inventory value comprises a value between 0.55 and 1.45 units.

12. The system according to claim 10, wherein said computer:
determines, for each one of said plurality of stores, an average rate of sale of said product;
compares, for each one of said plurality of stores, said average rate of sale to an average rate of sale threshold value; and
determines said store order forecast being by subtracting said random beginning on-hand inventory value from said sales forecast when said beginning on-hand inventory value is less than said minimum beginning inventory threshold value and said average rate of sale is less than said average rate of sale threshold value, and subtracting said beginning on-hand inventory value from said sales forecast when said beginning on-hand inventory value is not less than said minimum beginning inventory threshold value and said average rate of sale is not less than said average rate of sale threshold value.
